(19) United States
(12) Patent Application Publication
(10) Pub. No.: US 2022/0309543 A1
(43) Pub. Date: Sep. 29, 2022

(54) SYSTEMS, METHODS, AND APPARATUSES FOR CUSTOMIZING DIGITAL ADVERTISEMENTS

(71) Applicant: Wells Fargo Bank, N.A., San Francisco, CA (US)

(72) Inventors: Kristine Ing Kushner, Orinda, CA (US); John Wright, Benicia, CA (US)

(21) Appl. No.: 16/215,393

(22) Filed: Dec. 10, 2018

(51) Int. Cl. G06Q 30/02; G06F 16/538

(52) U.S. Cl. CPC G06Q 30/0271; G06Q 30/0276; G06F 16/538

(57) ABSTRACT

A provider computing system includes an image database structured to store an image relating to a user, an advertisement template database structured to store a plurality of advertisement templates, a tagging circuit structured to augment the image in the image database with one or more image attribute tags and augment each of the plurality of advertisement templates with a template attribute tag, a customization circuit coupled to the tagging circuit, the customization circuit structured to determine a match between the image and a first advertisement template of the plurality of advertisement templates based on the image attribute tags and the template attribute tags for the first advertisement template and integrate the image into the first advertisement template to generate a customized advertisement, and an advertisement selection circuit structured to cause the customized advertisement to be provided to the user.

### TECHNICAL FIELD

The present disclosure relates generally to the field of generating and customizing digital advertisements.

### BACKGROUND

Digital advertisements are often targeted for presentation to a user based on the user's demographics and/or internet browsing history. However and often times, user engagement with digital advertisements (i.e., the user acting on the advertisement, such as purchasing the advertised product or service, or visiting a website and/or a brick and mortar store associated with the advertised product or service) is lower than advertisers, website operators, and advertisement services may prefer.

One approach that may potentially improve user engagement with advertisements is increased tailoring of digital advertisements to individual users based on the users' personal data. However, such approaches may be over-intrusive and perceived as privacy violations by users, which may negatively impact the effectiveness of the advertisements. Existing technical solutions for providing digital advertisements are insufficient to achieve a nuanced balance between relevant, engaging advertisements and user privacy concerns.

Accordingly, systems and methods for accounting for privacy concerns while generating user-specific digital advertisements are desired.

### SUMMARY

One implementation of the present disclosure is a provider computing system. The provider computing system includes an image database structured to store an image relating to a user, an advertisement template database structured to store a plurality of advertisement templates, a tagging circuit structured to augment the image in the image database with one or more image attribute tags and augment each of the plurality of advertisement templates with a template attribute tag, a customization circuit coupled to the tagging circuit and structured to determine a match between the image and a first advertisement template of the plurality of advertisement templates based on the image attribute tags and the template attribute tag for the first advertisement template and integrate the image into the first advertisement template to generate a customized advertisement, and an advertisement selection circuit structured to cause the customized advertisement to be provided to the user.

Another implementation of the present disclosure is a method. The method includes storing an image relating a user, tagging the image with one or more image attribute tags, storing a plurality of advertisement templates, tagging each of the plurality of advertisement templates with a template attribute tags, determining a match between the image and a first advertisement template based on the image attribute tags and the template attribute tags for the first advertisement template, integrating the image into the first advertisement template to generate a customized advertisement, and providing the customized advertisement to the user.

Another implementation of the present disclosure is one or more non-transitory computer readable media containing program instructions that, when executed by one or more processors, cause the one or more processors to perform operations that include retrieving a first image from an image source, storing the first image in an image data object, determining a plurality of characteristics of the image, augmenting the image data object with a plurality of image attribute tags. The image attribute tags correspond to the plurality of characteristics. The operations also include storing a plurality of advertisement templates. Each advertisement template is stored in a template data object augmented by template attribute tags that characterize the advertisement template. The operations also include determining a match between the first image and a first advertisement template of the plurality of advertisement templates based on the image attribute tags for the first image and the template attribute tags for the first advertisement template, integrating the image into the first advertisement template to generate a customized advertisement, and causing the customized advertisement to be presented on a user device.

### BRIEF DESCRIPTION OF THE FIGURES

FIG. 1 is a block diagram of a system for providing customized digital advertisements to a user, according to an example embodiment.

FIG. 2 is a diagram showing data objects in an image database and in an advertisement template database of the system of FIG. 1, according to an example embodiment.

FIG. 3 is a flowchart of a process for generating and providing customized digital advertisements to a user, according to an example embodiment.

FIG. 4 is an illustration of an advertisement template, according to an example embodiment.

FIG. 5 is a first example embodiment of a customized advertisement generated by the system of FIG. 1.

FIG. 6 is a second example embodiment of a customized advertisement generated by the system of FIG. 1.

FIG. 7 is a third example embodiment of a customized advertisement generated by the system of FIG. 7.

### DETAILED DESCRIPTION

Referring generally to the Figures, systems, methods, and apparatuses for generating custom digital advertisements that balance potential privacy concerns for a user are shown, according to various embodiments herein. Balancing personalization of content for digital advertisements with user concerns about privacy presents a challenging technical problem to which the systems, methods, and apparatuses disclosed herein provide a concrete, technical solution.

As described herein, the systems, methods, and apparatuses may generate, store, and utilize augmented image data objects that combine image files with multiple attribute tags that characterize the corresponding images. The systems, methods, and apparatuses described herein may also generate, store, and utilize augmented advertisement template data objects that combine template files with multiple attribute tags that characterize the corresponding advertisement templates. This tagging approach, as illustrated in the FIGURES and described below, may reduce the amount of computer memory (e.g., database storage) required to store images, templates, and relevant characteristics thereof. The tagging approach may also eliminate computational expenses of re-association of characteristics with images or templates which may be required in alternative embodiments in which characteristics are stored separately from the image files or template files. Additionally, based on the attributed tags, a tagged image file may be integrated into an advertisement template data object to create a customized advertisement targeted at a particular user. These integrated files may be pre-generated and stored until a request triggers presentation of a customized advertisement to a user via the user device.

Furthermore, the systems, methods, and apparatuses described herein provide intimacy level tags in image data objects and template data objects that facilitate a tailoring of digital advertisements to match user expectations of online privacy in various browsing sessions. The problem of differentiating and adapting to variable user perceptions of privacy across websites, applications, browsing sessions, etc. is a problem particular to internet-based digital advertising. As used herein, an “intimacy level” is a value (in particular, a numerical value) that characterizes the degree to which a user is predicted to perceive an image, an advertisement, or a browsing session as intimate (e.g., personal, private). An intimacy level may be automatically assigned using a machine-learning approach, artificial intelligence approach, or other scoring system. As described below, intimacy levels may be used to automatically match images to templates having the same or similar intimacy levels and used to present advertisements in appropriate browsing sessions (i.e., appropriately intimate or non-intimate browsing sessions). The systems, methods, and apparatuses described herein thereby provide technical solutions to the challenge of exploiting user data to provide effective advertisements without the user perceiving advertisements as overly invasive or intrusive.

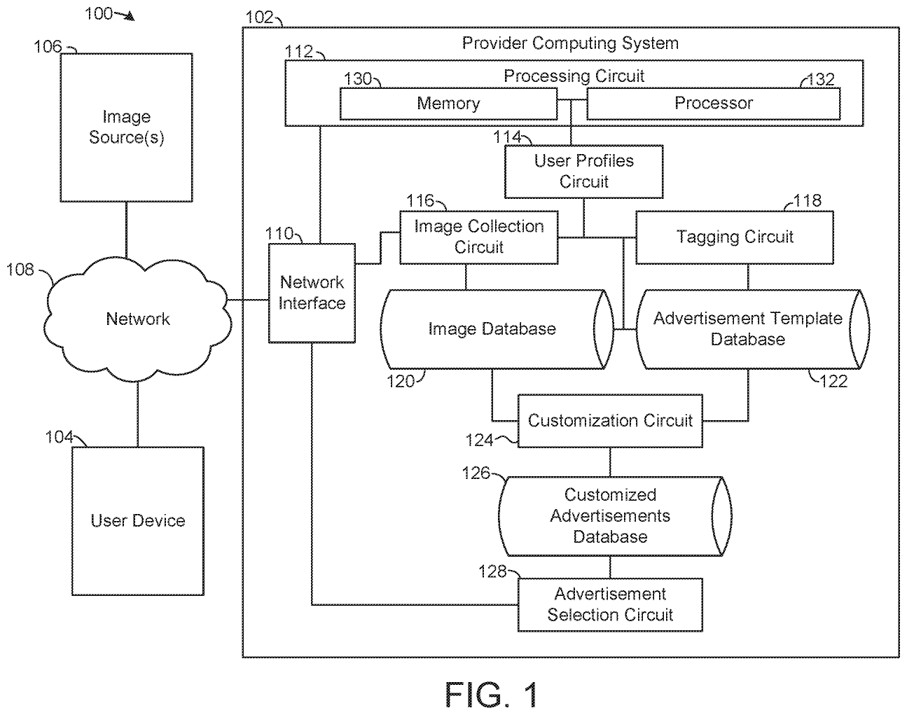

Referring now to FIG. 1, a system 100 for generating customized advertisements and presenting the customized advertisements to users is shown, according to an example embodiment. The system 100 includes a provider computing system 102 communicably coupled to a user device 104 and one or more image sources 106 via a network 108. While the embodiments herein are described with reference to a single user of one user device 104, it should be understood that the system 100 may be implemented for simultaneous or approximately simultaneous use with multiple user devices 104 associated with multiple users and/or a user device 104 sequentially used by multiple users.

The network 108 provides communicable and operable coupling between the user device 104, the one or more image sources 106, and the provider computing system 102. In various embodiments, the network 108 includes any type or types of network, including wired (e.g., Ethernet, optical fiber) and/or wireless networks (e.g., 802.11X, ZigBee, Bluetooth, Wi-Fi, cellular, Internet). In some embodiments, the network 108 includes an encrypted network to provide secure or substantially secure communications.

The user device 104 is structured to allow a user to access one or more webpages, applications, programs, etc. via the network 108 and to receive digital advertisements at such webpages, applications, programs, etc. The user device 104 is structured to allow a user to receive information from the user device 104 and input information to the user device 104. The user device 104 may be a smartphone, tablet, laptop, desktop computer, gaming system, augmented reality device, virtual reality device, wearable device, etc. including various combinations thereof. The user device 104 includes a network interface that facilitates communication between the user device 104 and the network 108.

The user device 104 may be associated (e.g., owned by, leased by, etc.) with a particular user. In some embodiments, the user device 104 may require the user to input a credential or credentials (e.g., password, biometric data (e.g., fingerprint), etc.) to verify the user's identity before allowing the user to operate the user device 104. The user device 104 may have an IP address or other device identifier that allows identification of the user device 104 on the network 108 and/or by the provider computing system 102. In some embodiments, the user device 104 may be associated with several users (e.g., members of a family) and/or may be a public device used by many users (e.g., located in a library, etc. and available for public use). In such a case, the user device 104 may provide a log-in page or some other system for enabling authentication or verification of the identity of a particular user.

The one or more image source(s) 106 are structured to store one or more images relating to one or more users. In some embodiments, the image source(s) 106 also store video and/or audio relating to the user. While the bulk of the disclosure below is with reference to “images” relating to the one or more users, it should be understood that the various functions and features described herein may also be applied to/with video and/or audio. In various embodiments, the image source(s) 106 include one or more of a cloud-based image storage system (e.g., Google Photos™, iCloud®, etc.), a social media platform (e.g., Facebook®, Instagram®, Tumbler®, VSCO®), local storage on a user device 104, and/or various other sources of photographs taken by a user, uploaded by a user, shared by a user, showing the user, and/or otherwise associated with the user. In some embodiments, the image source(s) 106 is a database or multiple databases, such as a service provider image database. The database may store, for example, images of service providers (e.g., bankers, financial advisors, lawyers, doctors, etc.) that may provide one or more services to the user. For example, the image source(s) 106 may store a headshot of a user's financial advisor or personal banker.

The provider computing system 102 is structured to generate and provide customized digital advertisements. The provider computing system 102 is shown to include a network interface 110, a processing circuit 112, a user profiles circuit 114, an image collection circuit 116, a tagging circuit 118, an image database 120, an advertisement template database 122, a customization circuit 124, a customized advertisements database 126, and an advertisement selection circuit 126, communicably and operably coupled to one another and described in further detail below. The provider computing system 102 is structured to execute the various functions attributed thereto herein.

Network interface 110 includes program logic that facilitates connection of the provider computing system 102 to the network 108. Accordingly, the network interface 102 supports communications via the network 102 among the provider computing system 102, the user device 104, and the image source(s) 106. The network interface 102 may include a cable modem, a broadband modem, a cellular modem, a Bluetooth transceiver, a Bluetooth beacon, a radio-frequency identification (RFID) transceiver, and/or a near-field communication (NFC) transmitter. In some embodiments, the network interface 102 includes cryptography capabilities to establish a secure or relatively secure communication session.

The processing circuit 112 is structured to control, at least in part, the provider computing system 102 as described herein. The processing circuit 112 includes memory 130 and processor 132. The processor 132 may be implemented as a general or special purpose processor, an application specific integrated circuit (ASIC), one or more field programmable gate arrays (FPGAs), a digital signal processor (DSP), a group of processing components, or other suitable electronic processing components. The one or more memory devices of memory 130 (e.g., RAM, ROM, NVRAM, Flash Memory, hard disk storage, etc.) may store data and/or computer code for facilitating at least some of the various processes described herein. In this regard, the memory 130 may store programming logic that, when executed by the processor 132, controls the operation of the provider computing system 102.

The user profiles circuit 114 is structured to create, store, and/or update user profiles. For example, the user profiles circuit 114 may store a user profile for the user associated with the user device 104. The user profile may include user identifying information (e.g., name, phone number, IP address, account number, username, password, biometric security data). The user profile may also include information identifying the available image source(s) 106 for the user, which may include a user's social media handle, login information, and permissions, cloud-storage photo library login information or sharing permissions, or other relevant preferences or access information.

In some embodiments, the user profile stored by the user profiles circuit 114 includes user financial data or other proprietary user consumption information available to the provider associated with the provider computing system. For example, in some embodiments the provider is a financial institution (e.g., bank, credit union, etc.) and the user profile information includes proprietary user consumption information relating to the user's enrollment in products and/or services offered by the financial institution, account balances in user accounts managed by the financial institution, identities of employees (e.g., personal bankers, financial advisors, etc.) associated with the user, and/or other such information that may be useful in customizing advertisements for the user.

The user profile may also include various other data, preferences, and settings for the user. In some embodiments, the user profiles circuit 114 is structured to generate a graphical user interface that prompts a user to input various information for inclusion in the user profile for that user. The graphical user interface may be presented to the user on the user device 104 via network interface 110 and network 108, while user input of profile information may be transmitted from the user device 104 to the user profiles circuit 114 via the network 108 and the network interface 110. The user profiles circuit 114 may also collect user profile information from various other systems and sources in various embodiments.

The image collection circuit 116 is structured to collect images relating to the user from the one or more image source(s). In some embodiments, the image collection circuit 116 may be structured to collect videos and/or audio files relating to the user. The image collection circuit 116 may receive a user profile from the user profiles circuit 114 and use the user profile to locate and access the image source(s) 106. The image collection circuit 116 may identify and copy one or more images from the image source(s) 106 that may be useable in one or more digital advertisements customized for the user. For example, the image collection circuit 116 may be structured to identify the best pictures relating to the user based on a number of “likes” received for the image on a social media platform, a number of views of an image, or some other data point relating to the image.

The image collection circuit 116 may download, copy, scrape, etc. the identified images from the image source(s) 106 and provide the images to the image database 120. For example, in some embodiments, a credential for an image source 106 (e.g., a social media network) may be provided to the image collection circuit 116 from a user input. The image collection circuit 116 may then provide this credential to access the image source 106. In some cases, the image collection circuit 116 may cause an email or other form of notification to be provided to a user asking for permission to allow the image collection circuit 116 access to the user's account at the image source 106. If given, the image collection circuit then obtains images and other data regarding the user from the image source 106 (e.g., from a social media network). As another example, in some embodiments the image collection circuit 116 deploys a screen scraper approach that uses an internet search engine to search for the user and acquires images based on the search. In some embodiments, the image collection circuit 116 can present these images to the user for confirmation that the images relate to the user before use in the advertisements, systems, and methods described below.

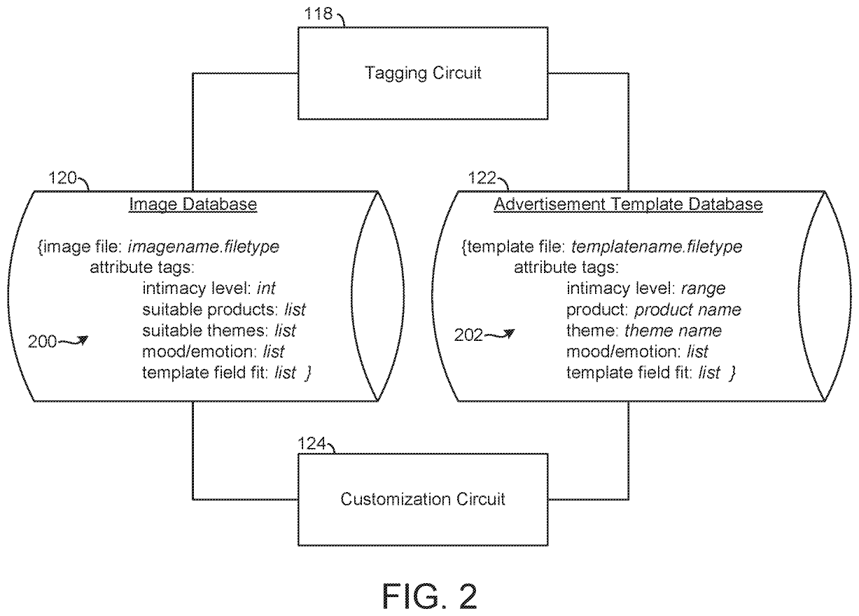

The image database 120 is structured to store the images. Each image is stored as an image file. As described in detail below, each image file stored in the image database may be augmented by one or more attribute tags that characterize the image. FIG. 2 shows a detailed view of the image database that illustrates the image file augmented with the one or more attribute tags, as described in detail below with reference thereto.

The tagging circuit 118 is structured to analyze each image to determine a set of attribute tags for each image. As used herein, a “tag” refers to a data point or points that describes an attribute (e.g., a characteristic) of an associated data file that is augmented by the tag, for example as illustrated in FIG. 2. Many possible attributes tags are possible in various embodiments, as described below with reference to FIG. 2. In some embodiments, the tagging circuit 118 executes a machine-learning-based image processing program to automatically determine attributes for each image. For example, the tagging circuit 118 may execute an image recognition program structured to determine the content of each image (i.e., who, what, where, etc. is shown in each image). The tagging circuit 118 may also use metadata to determine the content of the image or emotions relating to the image, for example social media captions, comments, or reactions associated with the image. The tagging circuit 118 may then assign attribute tags based the content of each image, for example using a Bayesian classifier approach. In some embodiments, the tagging circuit may also use the determined content of each image to determine an interest or hobby of a user and store the interest in the user profile (e.g., based on a high frequency of an object or location appearing in the images). In some embodiments, the tagging circuit 118 generates a graphical user interface that shows various images to a human tagging expert and assigns attribute tags in response to input from the human tagging expert. In some embodiments, the tagging circuit 118 may also be structured to employ machine learning to recursively improve the accuracy of tagging, which may be based on the end user's (or other group of recipients being modeled) level of acceptance of a customized advertisement that includes a tagged image. For example, the tagging circuit 118 may receive direct feedback (e.g., survey results) and/or tracking of subsequent actions relating to the customized advertising (e.g., views, interactions, sales), use such data to infer the accuracy of tagging, and use such inferences to update a neural network, Bayesian network, or other model/program used to determine and assign attribute tags.

The tagging circuit 118 is structured to augment each image file stored in the image database 120 with the determined attribute tags for that image. For example, the tagging circuit may be structured to cause the image database 120 to add determined attribute tags as metadata of the image file. The tagging circuit 118 and image database 120 are thereby structured to create an augmented image file that includes both the image (e.g., pixel color values) and attributes of the image.

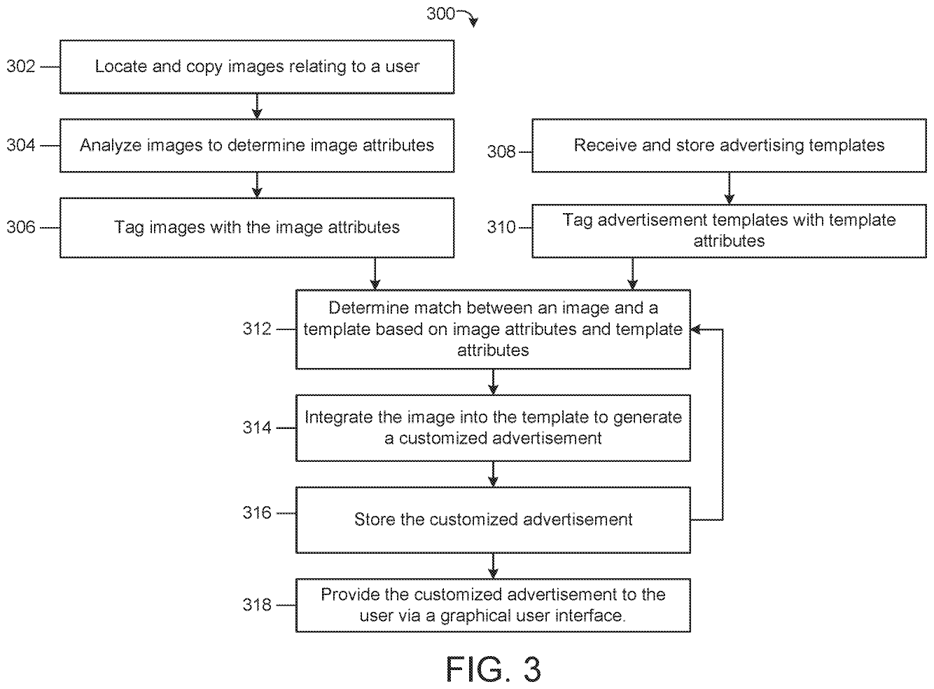

The advertisement template database 112 is structured to store advertisement templates. An advertisement template is a starting-point or base that can be modified using various customization features to generate a customized advertisement. For example, an advertisement template may have a set form, size, or shape (e.g., banner advertisement, pop-up, etc.) while including various fields for customization (e.g., blanks to be filled in with words, spaces for images to be added) and other customizable features (e.g., variable colors). An example advertisement template is shown in FIG. 3, and advertisement templates are described in detail with reference thereto. The advertisement template database 112 stores advertisement template files augmented with template attribute tags that characterize the templates, as shown in FIG. 2 and described in detail with reference thereto below. In some embodiments, the tagging circuit 118 is structured to automatically analyze the templates and assign the template attribute tags. In other embodiments, the template attribute tags are predefined (e.g., by an advertisement template designer).

The customization circuit 124 is structured to match an image from the image database 120 with an advertisement template from the advertisement template database 122 and generate a customized advertisement by incorporating the image into the advertisement template. The customization circuit 124 is structured to match the image with the advertisement template based on the attribute tags, for example based on matches between image attribute tags and template attribute tags. For example, an image and a template may both be augmented with an attribute tag that indicates that the image and the template are both are both associated with the same theme (e.g., football, entomology, vintage cars, beaches, family, religion), are both associated with the same mood or emotion (e.g., excited, cheerful, scared, romantic, etc.), are suitable for a browsing session with a similar intimacy level (described in detail below), and/or other tags. In some embodiments, the customization circuit 124 matches an image with an advertisement template if more than a threshold number of attribute tags match for the image and the advertisement template (e.g., three attributes, four attributes, all possible attributes, half of the possible attributes).

The customization circuit 124 is structured to integrate the matched image into the matched advertisement template. As shown in FIG. 3 and described with reference thereto, the advertisement template may include a preset field into which the image may be integrated (e.g., positioned, embedded, pasted). The customization circuit 124 may be structured to automatically crop, size, zoom, adjust brightness or contrast, or otherwise edit or filter the image to render the image suitable for addition to the advertisement template. For example, for an image that includes a headshot of a person, in some cases the customization circuit 124 may crop the image around the person to prevent the background from being added to the advertisement template. The attribute tags associated with the advertisement template may include instructions relating to any such image editing.

In addition to the image, the customization circuit 124 may also customize various other aspects of the advertisement template. For example, the customization circuit 124 may add a user's name to the advertisement template or the name of a person associated with the user (e.g., a service provider, a family member's name), may personalize a message about a product, and/or may otherwise customize the advertisement template to appeal to the user. The customization circuit 124 thereby transforms the advertisement template into a customized advertisement targeted to a particular user.

The customized advertisements database 126 is structured to store the customized advertisements generated by the customization circuit 124. That is, the customized advertisements may be pre-generated by the customization circuit 124 and then stored in the customized advertisements database 126 for an on-demand provision to a user as described below. In some embodiments, the customized advertisements database 126 may store each customized advertisement along with the attribute tags associated with the corresponding advertisement template and/or image. In some embodiments, the customized advertisement is characterized by a set of customized advertisement attributes stored as tags with the customized advertisements. The customized advertisements database 126 may store customized advertisements indefinitely or may delete customized advertisements and/or otherwise cause customized advertisements to be updated after a threshold time period. The customized advertisements database 126 may thereby store a set of up-to-date customized advertisements associated with a particular user.

The advertisement selection circuit 128 is structured to receive a request for an advertisement to be provided to the user device 104. The request may be provided from various sources in various embodiments. For example, the user may trigger a request to be provided to the advertisement selection circuit 128 by navigating, on the user device 104, to a view in a webpage or application that includes a field for an advertisement. In response to such a request, the advertisement selection circuit 128 is structured to select a customized advertisement from the customized advertisements database 126 and cause the customized advertisement to be presented on the user device 104. In some embodiments, the advertisement selection circuit 128 is structured to require a verification of the identity of the user from the user device 104 (e.g., an indication that the user entered a password or biometric information to access the user device) before causing the customized advertisement to be presented on the user device 104.

The request received by the advertisement selection circuit 128 may include various identifying information about the user, the browsing session, the webpage or application viewed by the user, the configuration of a field to be filled with the advertisement (e.g., size, shape, position on screen), the location of the user device 104, and/or other relevant information. For example, and assuming the user is engaged in a browsing session (e.g., using an internet search engine to search for various things), the request may identify whether the browsing session is secure, unsecure, private, public, etc. In some embodiments, the advertisement selection circuit 128 uses information from the user device 104 to determine where the user is located, what the user is doing, etc. and uses such information in selecting a customized advertisement from the custom advertisements database 126.

The advertisement selection circuit 128 may use such information about the browsing session and the webpage or application viewed by the user to determine an intimacy level of the browsing session. The intimacy level of the browsing session characterizes the degree to which a user perceives the browsing session as intimate (e.g., personal, private), which may correlate with how receptive a user may be to seeing personal information or a personal image appear in an advertisement for that particular browsing session. For example, a private, secure browsing session within a mobile banking application may be assigned a high intimacy level (e.g., Level 5 out of 5), while an unsecure browsing session on a public webpage may be assigned a low intimacy level (e.g., Level 1 out of 5). The advertisement selection circuit 128 may use various factors in determining the intimacy level of the browsing session, include a level of encryption of communications in the browsing session, whether a sign-on was required, whether a dual-factor authentication was required, whether the webpage or application viewed by the user is associated with the provider (e.g., a mobile banking application or webpage that provides access to services provided by the provider), a location of the user device (e.g., in a public place, in the user's home, at the user's work), etc. For example, each of those various factors may be determined and associated with a score using a look-up table. The scores may then be summed to generate the intimacy level of the browsing session.

The advertisement selection circuit 128 may then select a customized advertisement with an attribute tag indicating that the customized advertisement has a similar intimacy level (e.g., within a preset threshold) or a lower intimacy level than the intimacy level of the browsing session. The advertisement selection circuit 128 is thereby structured to prevent customized advertisements with high intimacy levels from being presented to a user during a low intimacy level browsing session, which may minimize the risk that a user will perceive an advertisement as invasive or creepy. The advertisement selection circuit 128 is thereby also structured to present highly personal, customized advertisements to the user within the context of highly intimate browsing sessions where the user may be more likely to accept and appreciate the inclusion of user personal information and images in digital advertisements. The provider computing system 102 may thereby strike a balance between user privacy concerns and enhanced user engagement with customized advertisements.

The advertisement selection circuit 128 is structured to cause the selected customized advertisement to be displayed on the user device 104. The user device 104 is structured to display the customized advertisement. The customized advertisement may be provided to the user device 104 via the network 108 and the network interface 110. In some embodiments, the provider computing system 102 provides the customized advertisement to an additional computing system coupled to the network 108 that operates the webpage or application for which an advertisement is requested. In such an embodiment, the additional computing system integrates the advertisement into a graphical user interface with elements of the webpage or application and provides the graphical user interface to the user device. In various embodiments, such an additional computing system may be included on the user device 104 or in the provider computing system 102.

It should be understood that the system 100 is highly configurable and that FIG. 1 shows one possible embodiment. For example, in some embodiments one or more of the image source(s) 106 may be included with the provider computing system 102 and/or with the user device 104. In some embodiments, some or all of the components 104-132 of the provider computing system 102 are included locally on the user device 104. Various other implementations are possible in various embodiments.

Referring now to FIG. 2, a detailed view of the image database 120 and the advertisement template database 122 communicably and operably coupled to the tagging circuit 118 and the customization circuit 124 is shown, according to an example embodiment. The image database 120 is shown to include an image data object 200 that includes an image file augmented with multiple attribute tags. The advertisement template database 122 is shown to include an advertisement template data object 202 that includes an advertisement template file augmented with multiple attribute tags. It should be understood that the image data object 200 and the advertisement template data object 202 are shown as examples of data objects stored at the image database 120 and the advertisement template database 122, respectively, and that many such image data objects 200 and advertisement template data objects 202 may be stored by the image database 120 and the advertisement template database 122.

The image data object 200 includes an image file retrieved from an image source 106 by the image collection circuit 116, indicated in FIG. 2 by the notation imagename.filetype. The image may have any name, including a descriptive name assigned by the image collection circuit 116 and/or a generic identifier (e.g., serial number) that serves to differentiate the image and the image data object 200 from other files stored in the image database 120. The image file may be stored in any suitable file type, for example .jpg, .png, etc.

The image data object 200 also includes multiple attribute tags assigned by the tagging circuit 118 that augment the image file. FIG. 2 shows several example attribute tags. It should be understood that these are includes as examples and that many various attribute tags may be included in various embodiments to describe various characteristics of the corresponding image.

The first attribute tag shown with the image data object 200 in the example of FIG. 2 is an intimacy level tag. The intimacy level tag characterizes a user's predicted perceived degree of intimacy (e.g., privacy, personal closeness) of the image on a numerical scale, for example on an integer scale (e.g., an integer between one and five). For example, a higher number may correspond to a higher intimacy level, while a lower number may correspond to a lower intimacy level. The tagging circuit 118 may be structured to process the image to determine an intimacy level of the image. For example, in some embodiments, the tagging circuit 118 may execute a machine-learning-based image processing program to determine various characteristics about the image, for example who is shown in the image, the emotion associated image, what objects or locations are shown in the image, etc., and then apply those determined characteristics to an algorithm that returns a numerical intimacy level based on the various determine characteristics. Characteristics used to determine the numerical intimacy level may also include the source of the image (e.g., a publically-shared social media post may be less intimate than an unshared photo from a cloud storage photo library), a location tagged on the image (e.g., metadata indicating GPS coordinates of where the image was captured), and various other information that may be available to the provider computing system 102. The tagging circuit 118 may thereby assign an intimacy level for the image and store the intimacy level as an attribute tag in an image data object 200 as shown in FIG. 2.

The second attribute tag shown with the image data object 200 in the example of FIG. 2 is a suitable products tag. The suitable products tag provides a list of products or types of products (or services/types of services) that are a good fit to advertise alongside the image. The tagging circuit 118 may be structured to execute a process or operation, such as a machine-learning-based image processing program, to determine a list of suitable products for the image, for example by selecting and/or eliminating products from a master list of possible products. For example, the tagging circuit 118 may determine that a picture of the user on a hiking trip may have corresponding suitable products that include hiking and camping gear, etc. As another example, the tagging circuit 118 may determine that the same products may not be suitable for an image of the user in formal attire (e.g., at a wedding, etc.). The suitable products tag may facilitate the customization circuit 126 in minimizing the risk of creating customized advertisements with jarring image-product combinations.

The third attribute tag shown with the image data object 200 in the example of FIG. 2 is a suitable themes tag. The suitable themes tag identifies possible thematic elements of advertisements that may make sense to use with the image. Such thematic elements may be independent of inherent properties of a product (e.g., a credit card may be advertised with a sports theme, a retirement investment product may be advertised with a beach vacation theme). The tagging circuit 118 may be structured to execute a machine-learning-based image processing program to determine a list of suitable themes for the image, for example by selecting and/or eliminating themes from a master list of possible themes. The suitable theme(s) for an image may correspond to an interest or hobby of the user. The suitable themes tag may thereby facilitate the customization circuit 126 in minimizing the risk of creating customized advertisements with jarring image-theme combinations and in providing customized advertisements that thematically reflect interests of the user.

The fourth attribute tag shown in the image database 200 is a mood/emotion tag. The mood/emotion tag characterizes a mood or emotion of the image (e.g., sad, happy, nostalgic, angry, excited, romantic, stressful, relaxed). The tagging circuit 118 may be structured to execute a machine-learning-based image processing program to determine one or more moods and/or emotions shown in the image. The mood/emotion tag may facilitate alignment of the mood/emotion of an image with the overall mood/emotion of a customized advertisement. The mood/emotion tag may also minimize the risk of creating customized advertisements with jarring/conflicting emotions/moods (e.g., a sad image in an advertisement with excited or happy text).

The fifth attribute tag shown with the image data object 200 is a template field fit attribute. The template field fit attribute may characterize how the image may fit into an advertisement template. For example, in some embodiments various advertisement templates are structured to incorporate images in various ways. For example, some templates may require a headshot to be added while some templates may require a landscape or cityscape images to be added as a background image. As another example, some templates may require a portrait-oriented image, while other templates require landscape-oriented images. The template field fit attribute in the image data object 200 may identify the way(s) in which the image corresponds to one or more of these types of template field requirements. The template field fit attribute may also identify objective image characteristics such as size, predominant color, brightness, contrast, etc. to facilitate fit and/or editing to match an advertisement template. The tagging circuit 118 may be structured to determine the template field fit attribute based on the image. Various additional and/or alternative attribute tags are possible in various embodiments.

The advertising template data object 202 includes an advertisement template file, denoted in FIG. 2 by templatename.filetype. The template may have any name, including a descriptive name and/or a generic identifier (e.g., serial number) that serves to differentiate the template and the template data object 202 from other files stored in the template database 120. The template file may be stored in any suitable file type, for example .html or a new, dedicate template file type (e.g., .adtemplate).

The template data object 202 also includes multiple attribute tags that augment the image file. The template attribute tags may be assigned by the tagging circuit 118 and/or by a user in a template design stage. FIG. 2 shows several example attribute tags. It should be understood that these are included as examples and that many various attribute tags may be included in various embodiments to describe various characteristics of the corresponding advertisement template.

In the example shown, each of the template attribute tags in the template data object 202 corresponds to one of the image attribute tags in the image data object 200 to facilitate matching of images to advertisement templates. In the example shown, the template data object 202 includes an intimacy level tag that corresponds to the intimacy level tag of the image data object 200, a product tag that corresponds to the suitable products tag of the image data object 200, a theme tag that corresponds to the suitable themes tag of the image data object 200, and a mood/emotion tag that corresponds to the mood/emotion tag of the image data object 200.

In the example shown, the intimacy level tag of the template data object 202 characterizes a user's predicted perceived degree of intimacy (e.g., privacy, personal closeness) of the advertisement template on a numerical scale, for example on an integer scale. For example, an advertisement template related to a sensitive service or product or theme may have a high intimacy level (e.g., divorce attorney services, family planning, etc.). The intimacy level of the advertisement template reflects the desired intimacy level of an image to be incorporated into the advertisement. The intimacy level tag of the template data object 202 may be a single value or indicate a range of intimacy levels. The intimacy level of an advertisement template may be predefined by an advertisement template designer, may be set using survey data from one or more users, or may be automatically determined using a machine-learning or

The product tag of the template data object 202 indicates the name of the product or products (or service or services) that the advertisement template is structured to advertise. In some embodiments, each advertisement template is pre-designed to advertise a particular product or service. In such a case, the product tag indicates the name or other identifier for that product or service. In some embodiments, an advertisement template may include a customizable field that allows the advertisement template to be adapted to advertise a variety of products or services. In such a case, the product tag may indicate a list of products and/or services suitable for advertisement using the template.

The theme tag of the template data object 202 indicates a theme of the advertisement, i.e., a characterization of thematic elements of the advertisement that may be unrelated or merely tangentially related to the advertised product or service. For example, the theme tag may indicate that the advertisement template has a sports theme, a nature theme, an urban theme, etc. The advertisement template includes corresponding thematic elements. The mood/emotion tag of the template data object 202 characterizes a mood and/or emotion of the advertisement template. For example, the advertisement template may be designed to attempt to invoke a sense of excitement, happiness, sadness, anger, nostalgia, success, etc. The mood/emotion tag identifies one or more moods and/or emotions evoked by the advertisement template.

The template field fit tag of the template data object 202 characterizes how an image may be incorporated into the advertisement template. For example, the template field fit tag may identify the content of the image that the template is designed to incorporate, for example a headshot of an individual (e.g., of the user, of a service provider associated with the user, etc.), a photograph of a family, a photograph of a pet, a photograph of a landscape, etc. As another example, the template field fit tag may identify a size, shape, orientation, location, etc. of a field (e.g., region) of the template structured to be filled by an image relating to the user. The template field fit tag may also identify various other instructions for incorporating an image into the template field structured to receive the image.

The image database 120 and the advertisement template database 122 are thereby structured to store files and attribute tags that facilitate the customization circuit 124 in generating customized advertisements. The customization circuit 124 is structured to access the image database 120 and the advertisement template database 122 and match image data objects 200 to template data objects 202 based on the attribute tags. In the example shown in FIG. 2, the customization circuit 124 may be structured to check whether the intimacy level tag of the image data object 200 is equal to and/or included within a range of the intimacy level tag of a template data object 202. The customization circuit 124 may be structured to check whether the product name tag of the template data object 202 is included in the suitable products tag of the image data object 200. The customization circuit 124 may be structured to check whether the theme tag of the template data object 202 is included in the suitable themes tag of the image data object 200 and whether the mood/emotion tag of the template data object 202 matches the mood/emotion tag of the image data object 200. The customization circuit 124 may also check whether the template field fit tag of the image data object 200 is compatible with the template field fit tag of the template data object 202.

In various embodiments, the customization circuit 124 may determine a match between the image data object 200 and the advertisement data object 202 if all attribute tags are compatible, if a majority of the attribute tags are compatible, etc. In some embodiments, a match between a particular attribute tag may be required for all matches while a match between another attribute tag may be optional but preferred in determining a match between an image and an advertisement template. In response to determining a match between an image data object 200 and an advertisement template data object 202, the customization circuit 124 generates a customized advertisement by incorporating the image file of the image data object 200 into the template file of the template data object 202.

Referring now to FIG. 3, a flowchart of a process 300 for generating and providing customized advertisements is shown, according to an example embodiment. The process 300 can be executed by the provider computing system 102 in communication with the user device 104 and the image source(s) 106 via the network 108.

At step 302, one or more images relating to a user are located and copied. For example, the image collection circuit 116 locates one or more images relating to a user in one or more image sources 106 and copies the located image(s) for storage at the provider computing system 102. The image collection circuit 116 may use various user profile information to identify relevant image source(s), access the image source(s), and identify relevant images in the image source(s). For example, the image collection circuit 116 may deploy artificial intelligence agents structured browse the image source(s) and locate the ‘best’ (e.g., most liked, most viewed, most beautiful, most meaningful) images in the image source(s). The provider image collection circuit 116 may download the identified images and cause the images to be stored in the image database 120.

At step 304, the images are analyzed to determine image attributes. For examples, the tagging circuit 118 analyzes the images to determine attributes of the images. The attributes may be of the various categories described with reference to FIG. 2 (e.g., intimacy level, suitable products, suitable themes, mood/emotion, template field fit). The tagging circuit 118 may execute a machine-learning-based image processing program to determine the attributes.

At step 306, the images are tagged with the image attributes. For example, the tagging circuit 118 tags the images with the image attributes determined at step 304. In other words, the tagging circuit 118 augments image files in the image database 120 with attribute tags that represent the determined attributes. The attribute tags may be stored in image data objects 200 with the image files as shown in FIG. 2 and described with reference thereto. Image data objects are thereby created, each of which provides an image and attributes/characteristics of the image.

At step 308, the provider computing system 102 receives and stores advertising templates. Advertising templates may be designed by advertising professionals and graphic designers for use in the customized advertising of process 300. In some embodiments, at step 308 the provider computing system 102 provides a portal and/or graphical user interface that facilitates design of advertising templates. Advertisement templates may be stored in the advertisement templates database 122. In some embodiments, templates in the advertisement templates database 122 may be edited and/or deleted by a system administrator or advertising professional. In some embodiments, new templates may be added at any time during the operation of the provider computing system 102.

At step 310, the advertisement templates received and stored at step 308 are tagged with template attributes. In other words, template files in the advertising template database 122 are augmented with attribute tags that characterize the templates. Attributes may be automatically determined by the tagging circuit 118 (e.g., using a machine-learning-based classification program) and/or manually assigned by an advertising professional. The attribute tags may be stored in template data objects 202 with the template files as shown in FIG. 2 and described with reference thereto.

At step 312, a match is determined between an image and a template based on image attributes and template attributes. For example, the customization circuit 124 determines a match between an image and template based on image attributes and template attributes. That is, the customization circuit 124 evaluates the image data objects in the image database 120 and the template data objects in the template database 122 and identifies an image data object for which the attribute tags are compatible with the attribute tags of a template data object. A match between the identified image data object and template data object (i.e., a match between the first image and the first template) is thereby established.

At step 314, the matched image is integrated into the matched template to generate a customized advertisement. The image may be sized, cropped, rotated, recolor, and/or otherwise filter to adapt the image to be suitable for integration into the first template. The template may have a predetermined field into which the image is inserted at step 314. Various other customizations may also be performed at step 314, including integrating the user's name into text or graphics of the customized advertisement, generating custom messages to provide in the customized advertisement, altering thematic elements of the customized advertisement, or otherwise tailoring the advertisement to the user.

At step 316, the customized advertisement is saved, for example stored in the customized advertisements database 126. The customized advertisement may be augmented by the attribute tags from the image data object and the template data object that were used to generate the customized advertisement and/or may be stored with a new set of attributes.

Steps 312-316 may be repeated to pre-generate multiple customized advertisements for a user. For example, in some embodiments, a customized advertisement is generated for all matches found between images and templates at step 312. The customized advertisements database 126 may thereby be populated with multiple pre-customized advertisements that may be provided on demand (i.e., approximately immediately at any time) without the need to perform customization functions in response to a request for an advertisement.

At step 318, a customized advertisement is provided to the user, for example via a graphical user interface of the user device 104. In some embodiments, at step 318 the provider computing system 102 receives an indication that the user has navigated to a view in a webpage or application for which a customized advertisement is to be provided. The provider computing system 102 may also receive various information about the browsing session of the user, including information that indicates an intimacy level of the browsing session. Based on the information about the browsing session and attribute tags stored with the customized advertisements, the advertisement selection circuit 128 identifies a customized advertisement suitable for presentation during the browsing session. The identified customized advertisement is then transmitted to the user device 104 for presentation to the user via a graphical user interface.

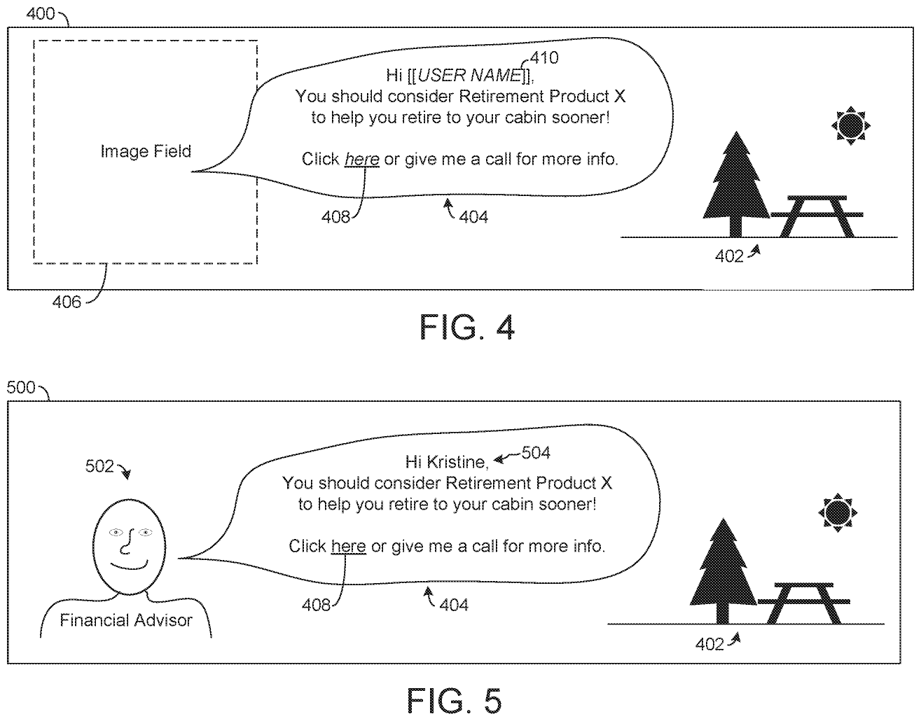

Referring now to FIG. 4, an example of an advertisement template 400 is shown, according to example embodiments. FIG. 4 shows the advertisement template before customization for a particular user, for example as stored in the advertisement templates database 122.

In the example of FIG. 4, the advertisement template 400 includes thematic elements 402, product information 404, and image filed 406. The thematic elements 402 provide design elements for the advertisement template 400 that may make the advertisement template 400 attractive to a user. In the example of FIG. 4, the thematic elements 402 show a scene of a picnic in the woods, corresponding to a theme of nature, camping, forests, parks, etc.

The product information 404 provides information about a product and/or service being marketed by the advertisement template 400. In the example of FIG. 4, the product information 404 is a retirement product (e.g., an investment product) offered by a financial advisor. As shown in FIG. 4, the product information 404 includes a link 408 to more information about the product. Any type of product or service may be advertised in various embodiments. The product information 404 includes a customization field 410 that indicates that the user's name is to be inserted into the customization field 410 to address the product information 404 directly to the user.

The image field 406 is structured to be filled by an image relating to the user. In the example of FIG. 4, the image field 406 is structured to be filled by a photograph or illustration of the user's financial advisor or personal banker. The image field 406 is prepositioned to give the impression that the product information 404 is being emitted from the image field 406.

Referring now to FIG. 5, a customized advertisement 500 generated using the advertisement template 400 of FIG. 4 is shown, according to an example embodiment. The customized advertisement 500 may be generated by the provider computing system 102 and/or by process 300. The custom advertisement 500 is a copy of the advertisement template 400 with the addition of an image 502 in the image field 406 and a user's name 504 in the customization field 410. The image 502 shows a headshot of the user's financial advisor, while the user's name 504 mentions the user directly. The customized advertisement 500 thereby directly appeals to the user by including the user's name 504 and presenting the image 502 of a person known to the user and trusted by the user to provide advice to the user. The customized advertisement 500 is also thematic targeted to the user with thematic elements 402. The customized advertisement 500 may therefore capture the user's attention and create the impression that the product is particularly well-suited and recommended for the user, which may increase the likelihood of the user engaging with the advertisement and seeking more information about the advertised product.

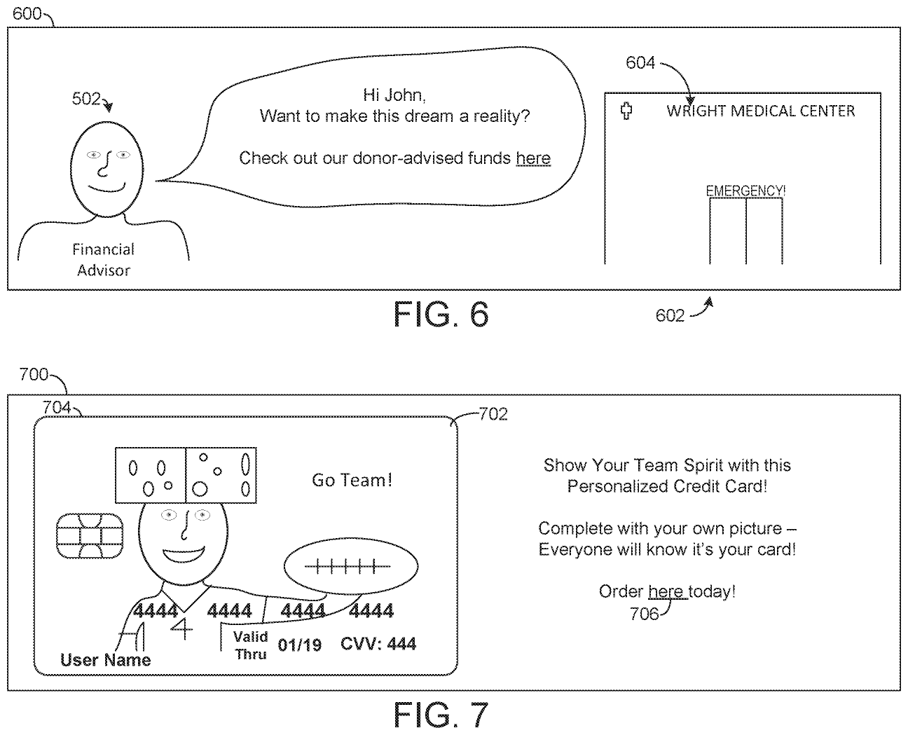

FIGS. 6-7 show additional examples of customized advertisements that can be generated by the provider computing system 102 and/or by process 300, according to example embodiments. FIG. 6 shows a customized advertisement 600 that attempts to market donor-advised funds offered by a financial institution. Like customized advertisement 500 of FIG. 5, the example customized advertisement 500 includes an image 502 of the user's financial advisor. In FIG. 6, the customized advertisement 600 includes thematic elements 602 that show a hospital building. In some embodiments, the thematic elements 602 may be customized such that the hospital building shown is a building recognizable to the user, for example a hospital frequented by the user. As shown in FIG. 6, the name of the hospital is customized to include the user's name 604. Accordingly, FIG. 6 illustrates an example of how thematic elements 602 may be customized to direct the customized advertisement 600 at a particular user.

FIG. 7 shows a customized advertisement 700 for a customized credit card 702. Customized advertisement 700 includes a graphical representation of a customized credit card 702 that includes an image 704 of the user. The image 704 may be copied from an image source 106 that may include a social media account or photo library of the user. In the example shown, the image 704 shows the user supporting his favorite sports team. To generate the customized advertisement 700, the tagging circuit 118 may determine that the image 704 shows the user supporting a sports team and identify the team, and include that information in the attribute tags stored with the image 704. As shown in FIG. 7, the image 704 is positioned on the customized credit card 702 to show a customized product marketed to the user by customized advertisement 700. Because the customized advertisement 700 includes the user's own image, the customized advertisement 700 may be highly likely to capture the user's attention.

It should be understood that FIGS. 4-7 show a limited number of example of images, templates, and advertisements for illustrative purposes and that many possible images, templates, and advertisements may be generated by the provider computing system 102 and/or via process 300 in various embodiments. Furthermore, as alluded to by the customized credit card 702 in FIG. 7, the systems and methods described herein may also be used to facilitate the design, marketing, and production of customized products that include one or more images relating to the user. For example, in the example of FIG. 7, if a user selects a link 706 to order a credit card, the provider computing system 102 may cause the image 704 to be printed on real credit card to be shipped to the user. The present disclosure contemplates many such examples.

The embodiments described herein have been described with reference to drawings. The drawings illustrate certain details of specific embodiments that implement the systems, methods and programs described herein. However, describing the embodiments with drawings should not be construed as imposing on the disclosure any limitations present in the drawings.

It should be understood that no claim element herein is to be construed under the provisions of 35 U.S.C. § 112(f), unless the element is expressly recited using the phrase “means for.”

As used herein, in various embodiments, the term “circuit” includes hardware structured to execute the functions described herein. In some embodiments, each respective “circuit” includes machine-readable media for configuring the hardware to execute the functions described herein. The circuit is embodied as one or more circuitry components including, but not limited to, processing circuitry, network interfaces, peripheral devices, input devices, output devices, sensors, etc. In some embodiments, a circuit takes the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” includes any type of component for accomplishing or facilitating achievement of the operations described herein. In one example, a circuit as described herein includes one or more transistors, logic gates (e.g., NAND, AND, NOR, OR, XOR, NOT, or XNOR), resistors, multiplexers, registers, capacitors, inductors, diodes, wiring, and so on.

In other embodiments, the “circuit” includes one or more processors communicably coupled to one or more memories or memory devices. In this regard, the one or more processors execute instructions stored in the memory or execute instructions otherwise accessible to the one or more processors. In various arrangements, the one or more processors are embodied in various ways and are constructed in a manner sufficient to perform at least the operations described herein. In some embodiments, the one or more processors are shared by multiple circuits (e.g., circuit A and circuit B comprise or otherwise share the same processor which, in some example embodiments, executes instructions stored, or otherwise accessed, via different areas of memory). Additionally, in various arrangements, a given circuit or components thereof (e.g., the one or more processors) are disposed locally (e.g., as part of a local server or a local computing system) or remotely (e.g., as part of a remote server such as a cloud based server). To that end, in certain arrangements, a “circuit” as described herein includes components that are distributed across one or more locations.

As used herein, a processor is implemented as a general-purpose processor, an application specific integrated circuit (ASIC), one or more field programmable gate arrays (FPGAs), a digital signal processor (DSP), a group of processing components, or other suitable electronic processing components. Additionally, in some arrangements, a “processor,” as used herein, is implemented as one or more processors. In certain embodiments, the one or more processors are structured to perform or otherwise execute certain operations independent of one or more co-processors. In other example embodiments, two or more processors are coupled via a bus to enable independent, parallel, pipelined, or multi-threaded instruction execution. In some arrangements, the one or more processors take the form of a single core processor, multi-core processor (e.g., a dual core processor, triple core processor, or quad core processor), microprocessor, etc. In some embodiments, the one or more processors are external to the apparatus, for example, the one or more processors are a remote processor (e.g., a cloud based processor). Alternatively, or additionally, the one or more processors are internal and/or local to the apparatus. Accordingly, an example system for implementing the overall system or portions of the embodiments might include a general purpose computing computers in the form of computers, including a processing unit, a system memory, and a system bus that couples various system components including the system memory to the processing unit.

Additionally, as used herein, a memory includes one or more memory devices including non-transient volatile storage media, non-transient non-volatile storage media, non-transitory storage media (e.g., one or more volatile and/or non-volatile memories), etc. that stores instructions that cause the processing circuit or computing system to perform the aforementioned described processes or operations herein. In some embodiments, the non-volatile media takes the form of ROM, flash memory (e.g., flash memory such as NAND, 3D NAND, NOR, or 3D NOR), EEPROM, MRAM, magnetic storage, hard discs, optical discs, etc. In some embodiments, the volatile storage media takes the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. In various arrangements, each respective memory device is operable to maintain or otherwise store information relating to the operations performed by one or more associated circuits, including processor instructions and related data (e.g., database components, object code components, or script components), in accordance with the example embodiments described herein.

It should be understood that a “network interface,” as used herein, includes any of a cellular transceiver (Code Division Multiple Access (CDMA), Global System for Mobile Communications (GSM), Long-Term Evolution (LTE), etc.), a wireless network transceiver (e.g., 802.11X, ZigBee, or Bluetooth), or a combination thereof (e.g., both a cellular transceiver and a Bluetooth transceiver). In some arrangements, a network interface includes hardware and machine-readable media sufficient to support communication over multiple channels of data communication. Further, in some arrangements, the network interface includes cryptography capabilities to establish a secure or relatively secure communication session between the device including the network interface and other devices of the system 100 via the network 110. In this regard, data is encrypted and transmitted to prevent or substantially prevent the threat of hacking.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein show a specific order and composition of method steps, it is understood that in various embodiments the order of these steps differs from what is depicted. As an example, two or more steps are performed concurrently or with partial concurrence. Also, in various embodiments, some method steps that are performed as discrete steps are combined, steps being performed as a combined step are separated into discrete steps, the sequence of certain processes is reversed or otherwise varied, and/or the nature or number of discrete processes is altered or varied. Furthermore, the order or sequence of any element or apparatus is varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques, with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or as acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions can be made to the design, operating conditions and arrangement of the embodiments without departing from the scope of the present disclosure as expressed in the appended claims.

1. A provider computing system, comprising:
an image database structured to store an image relating to a user as an image file;
an advertisement template database structured to store a plurality of advertisement templates as advertisement template files;
a tagging circuit coupled to the image database and the advertisement template database, the tagging circuit structured to:
augment the image in the image database with an image attribute tag indicating at least a first integer value representing an intimacy level of the image, wherein the image attribute tag is integrated with and stored with the image file;
augment each of the plurality of advertisement templates with a template attribute tag indicating at least a second integer value representing an intimacy level of the advertisement template, wherein the template attribute tags are integrated with and stored with the advertisement template files;
a customization circuit coupled to the tagging circuit, the customization circuit structured to:
determine a match between the image and a first advertisement template of the plurality of advertisement templates by reading and comparing the image attribute tag from the image file and the template attribute tag for the first advertisement template from the advertisement template file for the first advertisement template, wherein the customization circuit is structured to determine the match between the image and the first advertisement template by determining that the first integer value is within a range of the second integer value of the first advertisement template;
integrate the image into the first advertisement template by combining the image file and the advertisement template file for the first advertisement template to generate a customized advertisement, wherein an intimacy level associated with the customized advertisement is represented by at least one of the first integer value or the second integer value; and
an advertisement selection circuit structured to:
cause the customized advertisement to be provided to the user if the at least one of the first integer value or second integer value is less than or equal to a third integer value representing an intimacy level of a current browsing session of the user; and
prevent the customized advertisement from being provided to the user if the at least one of the first integer value or second integer value is greater than the third integer value;
wherein:
the customized advertisement comprises a selectable option to execute a production and shipping action; and
the provider computing system is configured to cause execution of the production and shipping action in response to selection of the selectable option, wherein the production and shipping action comprises printing the image on a credit card and shipping the credit card to the user.

2. (canceled)

3. (canceled)

4. (canceled)

5. The system of claim 1, wherein the image comprises a photograph of an advisor of the user.

6. The system of claim 1, further comprising an image source structured to store the image and a plurality of additional images relating to the user, wherein the image source comprises one or more of a social media platform, a cloud-based image storage database, or a local memory on a user device; and
wherein the provider computing system comprises an image aggregation circuit structured to retrieve the image from the image source.

7. The system of claim 6, wherein the customization circuit is structured to add a name of the user to the customized advertisement.

8. A method, comprising:
storing an image relating to a user as an image file;
tagging the image with an image attribute tag indicating at least a first integer value representing an intimacy level of the image, wherein the image attribute tag is integrated with and stored with the image file;
storing a plurality of advertisement templates as advertisement template files;
tagging each of the plurality of advertisement templates with a template attribute tag indicating a second integer value representing an intimacy level of the advertisement template, wherein the template attribute tags are integrated with and stored with the advertisement template files;
determining a match between the image and a first advertisement template by reading and comparing the image attribute tag from the image file and the template attribute tag from the advertisement template file for the first advertisement template and determining that the first integer value is within a range of the second integer value;
integrating the image into the first advertisement template by combining the image file and the advertisement template file for the first advertisement template to generate a customized advertisement, wherein at least one of the first integer value or the second integer value is associated with the customized advertisement; and
providing the customized advertisement to the user if the at least one of the first integer value or the second integer value is less than or equal to a third integer value associated with a current browsing session of the user, wherein providing the customized advertisement comprises providing a selectable option to execute production and shipping of a customized product;
preventing the customized advertisement from being provided to the user if the at least one of the first integer value or the second integer value is greater than the third integer value; and
executing the production and shipping action of the customized product in response to selection of the selectable option by printing the image on a credit card and shipping the credit card to the user.

9. (canceled)

10. (canceled)

11. (canceled)

12. The method of claim 8, wherein the image relating to the user comprises a photograph of an advisor of the user.

13. The method of claim 8, comprising scraping the image from an image source structured to store a plurality of additional images relating to a user, wherein the image source comprises one or more of a social media platform, a cloud-based image storage database, or local memory on a user device.

14. The method of claim 13, comprising:
analyzing the image and the plurality of additional images relating to the user to determine an interest of the user;
determining, based on the interest of the user, a theme for the advertisement; and
selecting the first advertisement template based on the theme.

15. One or more non-transitory computer readable media containing program instructions that, when executed by one or more processors, cause the one or more processors to perform operations comprising:
retrieving a first image from an image source;
storing the first image in an image data object;
determining a plurality of characteristics of the image;
augmenting the image data object with a plurality of image attribute tags integrated into and stored with the image data object, the image attribute tags corresponding to the plurality of characteristics;
storing a plurality of advertisement templates, each advertisement template stored in a template data object augmented by template attribute tags that characterize the advertisement template, wherein the template attribute tags are integrated into and stored with the template data object;
determining a match between the first image and a first advertisement template of the plurality of advertisement templates by reading and comparing the image attribute tags for the first image from the image data object and the template attribute tags for the first advertisement template from the template data object for the first advertisement template;
integrating the image into the first advertisement template by adding image data from the image data object into the template data object for the first advertisement template to generate a customized advertisement; and
causing the customized advertisement to be presented on a user device if a first integer representing an intimacy level of the customized advertisement is less than or equal to a second integer representing an intimacy level of a current browsing session of the user, the customized advertisement comprising a selectable option to execute a production and shipping action;
preventing the customized advertisement from being provided to the user if the first integer is greater than the second integer; and
causing execution of the production and shipping action of the customized product in response to selection of the selectable option.

16. (canceled)

17. (canceled)

18. The non-transitory computer-readable media of claim 15, wherein the first image comprises a photograph of an advisor of the user or an image of the user.

19. The non-transitory computer-readable media of claim 15, the operations further comprising adding a name of the user to the customized advertisement.

20. The non-transitory computer-readable media of claim 15, the operations further comprising:
receive a verification of an identify of the user; and
requiring the verification of the identity of the user before causing the customized advertisement to be presented on the user device.

21. The non-transitory computer-readable media of claim 15, wherein the production and shipping action comprises causing the image to be printed on a credit card and shipping the credit card to the user.
